(19) United States
(12) Patent Application Publication
(10) Pub. No.: US 2025/0225589 A1
(43) Pub. Date: Jul. 10, 2025

(54) System and Method for Providing Insurance Deductible Coverage and Optimized Insurance Bundling

(71) Applicant: Franklin C. Ejenma, San Marcos, TX (US)

(72) Inventor: Franklin C. Ejenma, San Marcos, TX (US)

(21) Appl. No.: 19/010,380

(22) Filed: Jan. 6, 2025

Related U.S. Application Data
(60) Provisional application No. 63/617,964, filed on Jan. 5, 2024.

(51) Int. Cl. G06Q 40/08

(52) U.S. Cl. CPC G06Q 40/08

(57) ABSTRACT

The present invention is an insurance deductible coverage system. The system includes a mobile application and website interface that enable users to browse, select, and manage deductible costs, coverage, and insurance plans. A server with interconnected databases stores user profiles, insurance provider information, and claim records, while an API module provides real-time access to insurance data from approved providers. The system incorporates a risk assessment engine to analyze user data and claims history, enabling optimized bundling of premiums and deductible coverage tailored to user needs. Upon selection, the system generates a digital policy and processes deductible coverage payments. The system offers users a cost-effective, streamlined way to manage deductible expenses and insurance coverage.

### CROSS-REFERENCE TO RELATED APPLICATION

The present application claims priority to, and the benefit of, U.S. Provisional Application No. 63/617,964 which was filed on Jan. 5, 2024 and is incorporated herein by reference in its entirety.

### FIELD OF THE INVENTION

The present invention generally relates to insurance systems. More specifically, the invention relates to an insurance deductible coverage system. The system comprises a mobile application and website interface that enable users to browse, select, and manage deductible coverage alongside various insurance plans, providing a centralized, user-friendly platform. The system integrates with insurance providers through an application programming interface (API) to deliver real-time premium rate or costs, deductible details, and plan specifics, ensuring users have up-to-date information. Additionally, a risk assessment engine analyzes user data and claims history to suggest optimal deductible and premium bundling options tailored to individual user profiles. Accordingly, the present disclosure makes specific reference thereto. Nonetheless, it is to be appreciated that aspects of the present invention are also equally applicable to other like applications, devices, and methods of manufacture.

### BACKGROUND

By way of background, insurance policies play a critical role in both personal and financial security by providing individuals, families, and businesses with a safeguard against unforeseen events. Insurance policies help mitigate the financial impact of unexpected events, such as accidents, illnesses, natural disasters, or liability claims. Insurance policies are often structured to balance premium and deductible rates or costs, which directly impacts out-of-pocket expenses and monthly financial commitments of a policyholder. Commonly, insurance plans with lower monthly premiums are paired with higher deductibles, requiring policyholders to bear a significant financial responsibility before their insurance coverage becomes effective. Conversely, insurance plans offering low deductibles are often accompanied by substantially higher monthly premiums. Although these plans reduce immediate out-of-pocket costs when a claim is made, the recurring premium payments may be unaffordable or unsustainable for many individuals and families.

The financial trade-off between deductible and premium costs limits consumer choice, as individuals are required to choose between manageable premiums or affordable deductibles. Consequently, there is a growing need for a solution that provides policyholders with comprehensive coverage, reduced premium expenses, and financial support for deductibles.

Therefore, there exists a long-felt need in the insurance industry for a system that reduces the financial burden of high deductibles without increasing monthly premiums. There is a long-felt need in the art for a system that enables policyholders to select lower premium plans while minimizing or covering their deductible rates or costs during a claim. Also, there is a long-felt need in the art for an insurance system that enables individuals to manage their insurance and deductible coverage in one place. Further, there is a long-felt need for a system that provides real-time access to insurance options, premium rate or costs, and deductible coverage costs, enabling users to make informed choices. Moreover, there is a long-felt need for a system that includes automated claims processing and verification to ensure rapid reimbursement of deductible amounts. Finally, there is a long-felt need for a system that ensures individuals can obtain insurance coverage with the lowest pricing for both premiums and deductibles.

The subject matter disclosed and claimed herein, in one embodiment, comprises an insurance deductible coverage system designed to address the limitations of traditional insurance models. The system includes a mobile application and website that enable users to browse, select, and manage their deductible coverage alongside their existing or new insurance plans. A server infrastructure supports interconnected databases for customer information, insurance provider details, and claims history. The system integrates an application programming interface (API) module that connects with insurance providers to offer users real-time access to premium rate or costs, deductible options, and plan specifics, simplifying the decision-making process. The system features a claims verification module that cross-references deductible claims with insurance providers, validating claims and initiating prompt reimbursement to reduce out-of-pocket expenses for users.

In this manner, the insurance deductible coverage system of the present invention accomplishes all of the foregoing objectives and provides users with a cost-effective, accessible, and efficient solution for managing insurance deductibles. The system includes a user-friendly mobile application and website, enabling policyholders to review bundled insurance options and deductible plans that meet their financial needs. The real-time API integration provides users with current premium rate or costs and deductible coverage, enabling them to optimize coverage and premiums. The system helps policyholders mitigate the financial impact of insurance deductibles seamlessly and with minimal manual intervention.

### SUMMARY OF THE INVENTION

The following presents a simplified summary in order to provide a basic understanding of some aspects of the disclosed innovation. This summary is not an extensive overview, and it is not intended to identify key/critical elements or to delineate the scope thereof. Its sole purpose is to present some general concepts in a simplified form as a prelude to the more detailed description that is presented later.

The subject matter disclosed and claimed herein, in one embodiment thereof, comprises an insurance deductible coverage system. The system comprises a mobile application configured to enable a user to browse, select, and manage a deductible coverage associated with an insurance policy, a server is in communication with the mobile application, the server comprises a customer database for storing user information, an insurance provider database for maintaining a list of approved insurance providers, insurance plans, premium rate or costs, and deductible details, a claims database for storing deductible claims, statuses, dates, amounts, and verification details to track user claim history. An application programming interface (API) module is configured to interface with insurance providers to receive real-time premium rate or costs, deductible details, and plan specifics for updating the insurance provider database. A risk assessment engine is configured to analyze user data and claims history to suggest cost-effective deductible and premium bundling options.

In another aspect, a claim verification module is configured to validate claims submitted through the mobile application by cross-referencing with an insurance provider's database and initiating a deductible reimbursement upon successful verification.

In another embodiment, a method of providing deductible coverage for insurance policyholders is disclosed. The method includes the steps of receiving, via a mobile application or website, user inputs for an insurance policy, including information on desired coverage level, deductible amount, and budget constraints, querying an insurance provider database to retrieve a list of insurance plans and associated deductible options based on the user inputs, applying a risk assessment engine to calculate optimal premium and deductible bundling for the user, based on claims history and current user needs, presenting, via the mobile application or website, the retrieved insurance plans and deductible coverage options as bundled rates to the user, including estimated savings, receiving user selection of an insurance plan and deductible coverage, and generating a digital deductible coverage policy upon receiving the payment of the deductible coverage fee from the user.

In yet another aspect, an insurance selection and deductible bundling system is disclosed. The system includes a server, the server comprises a customer database to store user profiles, policy selections, and payment details, an insurance provider database storing insurance plan details, premiums, and deductible options from various insurance providers, a risk assessment and optimization engine configured to analyze user data, claim history, and risk profiles to recommend deductible coverage options with optimal premium savings, an application programming interface (API) configured to receive and update insurance plan information in real-time from insurance providers, and a mobile application and website, both configured to provide users with access to the server for browsing and comparing insurance plans, viewing bundled deductible options, and selecting insurance and deductible coverage plans.

In yet another aspect, the system processes monthly or annual deductible coverage fees from users and automatically updates the customer database with payment history and subscription status upon successful transaction completion.

In still another aspect, the system sends real-time notifications to the user, via the mobile application or website, regarding changes in premium rate or costs, deductible adjustments, and policy renewal reminders.

Numerous benefits and advantages of this invention will become apparent to those skilled in the art to which it pertains upon reading and understanding of the following detailed specification.

To the accomplishment of the foregoing and related ends, certain illustrative aspects of the disclosed innovation are described herein in connection with the following description and the annexed drawings. These aspects are indicative, however, of but a few of the various ways in which the principles disclosed herein can be employed and are intended to include all such aspects and their equivalents. Other advantages and novel features will become apparent from the following detailed description when considered in conjunction with the drawings.

### BRIEF DESCRIPTION OF THE DRAWINGS

The description refers to provided drawings in which similar reference characters refer to similar parts throughout the different views, and in which:

FIG. 1 illustrates a schematic view of insurance deductible coverage system of the present invention in accordance with the disclosed structure;

FIG. 2 illustrates a flow chart depicting a process of insurance plan selection and rate shopping using the system of the present invention in accordance with the disclosed architecture;

FIG. 3 illustrates a flow chart depicting a process of deductible coverage flow and claims submission in accordance with one embodiment of the present invention;

FIG. 4 illustrates a flow chart depicting a process of policy renewal for the deductible coverage in accordance with one embodiment of the present invention;

FIG. 5 illustrates an exemplary user interface displayed by the application and website for selection of a deductible coverage in accordance with the disclosed architecture; and

FIG. 6 illustrates a user interface shown to a user by the system for successful deductible coverage in accordance with one embodiment of the present invention.

### DETAILED DESCRIPTION OF THE PRESENT INVENTION

The innovation is now described with reference to the drawings, wherein like reference numerals are used to refer to like elements throughout. In the following description, for purposes of explanation, numerous specific details are set forth in order to provide a thorough understanding thereof. It may be evident, however, that the innovation can be practiced without these specific details. In other instances, well-known structures and devices are shown in block diagram form in order to facilitate a description thereof. Various embodiments are discussed hereinafter. It should be noted that the figures are described only to facilitate the description of the embodiments. They are not intended as an exhaustive description of the invention and do not limit the scope of the invention. Additionally, an illustrated embodiment need not have all the aspects or advantages shown. Thus, in other embodiments, any of the features described herein from different embodiments may be combined.

As noted above, there exists a long-felt need in the insurance industry for a system that reduces the financial burden of high deductibles without increasing monthly premiums. There is a long-felt need in the art for a system that enables policyholders to select lower premium plans while minimizing or covering their deductible rates or costs during a claim. Also, there is a long-felt need in the art for an insurance system that enables individuals to manage their insurance and deductible coverage in one place. Further, there is a long-felt need for a system that provides real-time access to insurance options, premium rate or costs, and deductible coverage costs, enabling users to make informed choices. Moreover, there is a long-felt need for a system that includes automated claims processing and verification to ensure rapid reimbursement of deductible amounts. Finally, there is a long-felt need for a system that ensures individuals can obtain insurance coverage with the lowest pricing for both premiums and deductibles.

The present invention, in one exemplary embodiment, is an insurance selection and deductible bundling system. The system includes a server, the server comprises a customer database to store user profiles, policy selections, and payment details, an insurance provider database storing insurance plan details, premiums, and deductible options from various insurance providers, a risk assessment and optimization engine configured to analyze user data, claim history, and risk profiles to recommend deductible coverage options with optimal premium savings, an application programming interface (API) configured to receive and update insurance plan information in real-time from insurance providers, and a mobile application and website, both configured to provide users with access to the server for browsing and comparing insurance plans, viewing bundled deductible options, and selecting insurance and deductible coverage plans.

Reference will now be made in detail to the present preferred embodiments of the invention, examples of which are illustrated in the accompanying drawings. Wherever possible, the same reference numerals are used in the drawings and the description to refer to the same or like parts.

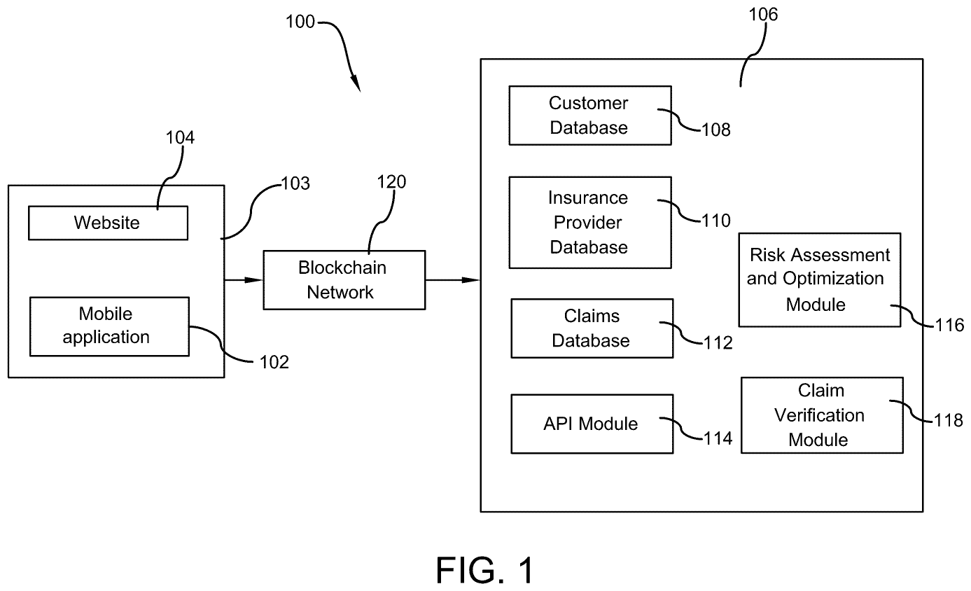

Referring initially to the drawings, FIG. 1 illustrates a schematic view of insurance deductible coverage system of the present invention in accordance with the disclosed structure. The insurance deductible coverage system 100 of the present invention is designed to minimize the financial impact of insurance deductibles on customers. The system 100 is configured to bundle deductible and premium costs to help consumers obtain insurance coverage with lower premium rate or costs while simultaneously covering the deductible through an additional, separate service. More specifically, the system 100 includes a mobile application 102 that enables users to browse, select, and manage their deductible coverage offered by the system 100. The mobile application 102 also enables users to browse and select insurance plans in addition to uploading details of their existing insurance plans. A website 104 is also configured to provide the same functionality as provided by the application 102. The application 102 and the website 104 are accessible in an electronic computing device 103 such as a laptop, smartphone, smartwatch, or any other similar device.

A server 106 is included in the system 100 and includes a customer database 108 which stores user information, including personal details, policy selections, deductible coverage details, and payment history. The customer database 108 stores user information about all the registered users of the system 100. An insurance provider database 110 is configured to maintain a list of approved insurance providers, their offered plan options, premium rate or costs, deductible details, and historical data on claims. The insurance provider database 110 is updated in real-time to include and exclude insurance providers from the database 110. As the system 100 is designed to cover the insurance deductibles, a claims database 112 is included in the system 100 which stores all deductible claims, statuses, dates, amounts, and verification details to track user claim history.

An application programming interface (API) module 114 interfaces with different insurance providers for receiving real-time access to premium rate or costs, deductible details, and plan specifics for different users. The real-time information is updated in the insurance provider database 110 and enables users to review and shop using the application 102 and the website 104. The API module 114 is also adapted to handle subscription fees of the system 100 and deductible reimbursements provided to the customers by the system 100.

A risk assessment and optimization engine or module 116 is included in the server 106 for analyzing user data, claims history, likelihood of a user making a claim for deducing deductible coverage pricing and premium plans to users. The engine or module 116 also calculates and suggests the most cost-effective deductible and premium bundling based on historical data and current user needs. It should be noted that all the information stored in different databases of the system 100 is encrypted both in transit and at rest. Further, role-based access is provided of the information to system administrators, insurance providers, and end-users, ensuring that only authorized personnel can access sensitive information.

A claim verification module 118 is configured to validate claims with insurance providers to ensure eligibility and accuracy of the claims before covering the deductible. The module 118 performs automated verification steps, reducing wait times for users for reimbursement of the deductible. Both the application 102 and the website 104 can access the deductibles and premium information offered by the system 100 using a communication network 120 which can be a public or private network.

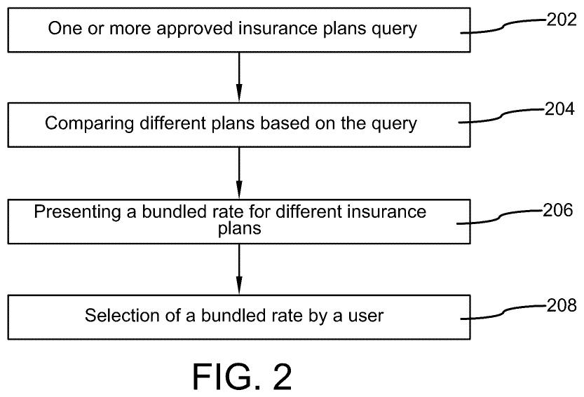

FIG. 2 illustrates a flow chart depicting a process of insurance plan selection and rate shopping using the system of the present invention in accordance with the disclosed architecture. A user using the application 102 or website 104 queries for one or more approved insurance plans by providing information such as insurance amount, duration, and age (Step 202). Then, the risk assessment and optimization engine or module 116 compares different plans and presents insurance options that align with the budget, deductible requirements, and preferred coverage level of the user (Step 204). Thereafter, the application/website presents a bundled rate including deductible coverage and premium, along with savings estimates provided by the bundled rate (Step 206). Finally, the user selects an insurance plan and deductible coverage bundle, and the system 100 records the selection in the user profile and provides an update to the insurance provider (Step 208). It should be noted that the system calculates a monthly or annual fee for the deductible coverage based on the selected insurance plan, deductible amount, and risk profile and when the payment is made by the user, the system 100 generates a digital deductible coverage policy.

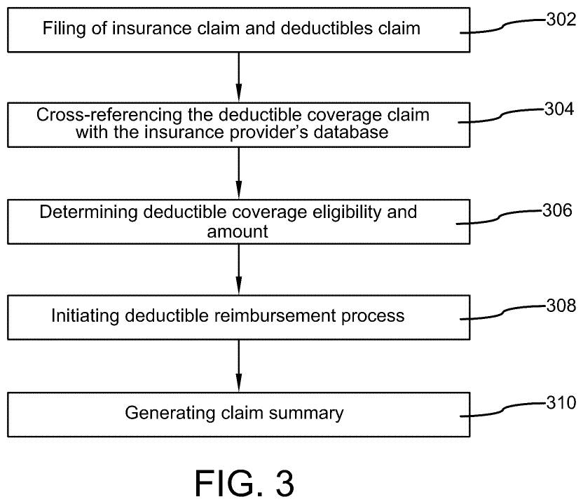

FIG. 3 illustrates a flow chart depicting a process of deductible coverage flow and claims submission in accordance with one embodiment of the present invention. The automated insurance deductible coverage system 100 provides deductible claim processing and provides deductible coverage to users without extensive manual steps. Initially, a user files an insurance claim with their insurance provider and simultaneously initiates a deductible coverage claim through the mobile application 102 or website 104 (Step 302). In some embodiments, the insurance claim can also be filed using the system 100 along with the deductible coverage claim.

Then, the automated insurance deductible coverage system 100 cross-references the deductible coverage claim with the insurance provider's database to verify the deductible coverage claim (Step 304). When the deductible coverage claim is verified, the system 100 calculates the deductible amount and determines eligibility based on the user's deductible coverage policy (Step 306). Thereafter, the system 100 automatically initiates the deductible reimbursement process and deposits the deductible amount either directly to the linked account of the user or as a credit with the insurance provider (Step 308). Finally, a claim summary is generated, recorded in the system 100, and shared with the user through the application 102 (Step 310).

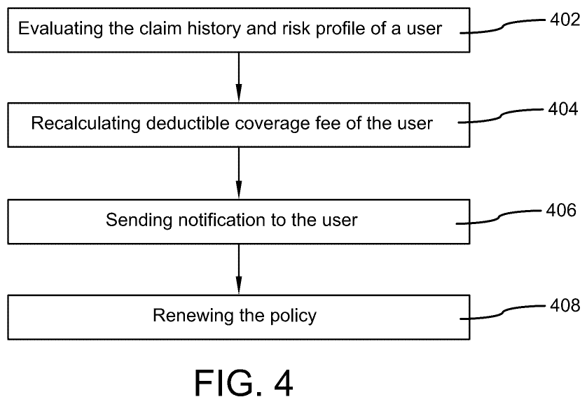

FIG. 4 illustrates a flow chart depicting a process of policy renewal for the deductible coverage in accordance with one embodiment of the present invention. The system 100 is configured to consider the latest risk data of users in maintaining deductible coverage fees and accordingly, the system 100 at predetermined intervals such as annually or bi-annually, evaluates the claim history and risk profile of a user (Step 402). Then, the system recalculates deductible coverage fee of the user based on the above inputs and market rates to reflect current risk and cost structures (Step 404). Thereafter, a notification of the updated fee is sent to the user and the system offers options for monthly or annual renewal (Step 406). Finally, based on the selection of the option and received renewal fees, the renewed policy document is generated and shared with the user (Step 408).

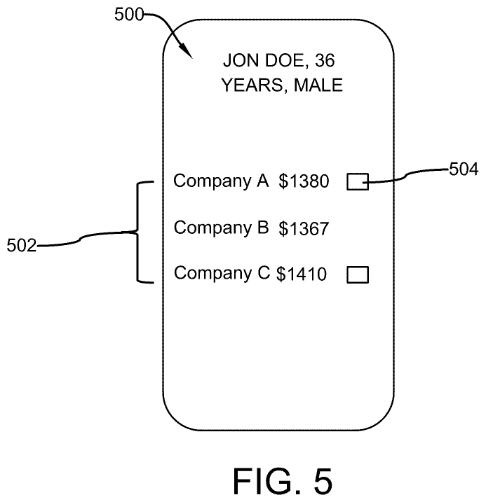

FIG. 5 illustrates an exemplary user interface displayed by the application and website for selection of a deductible coverage in accordance with the disclosed architecture. As illustrated, the interface 500 displays a list 502 of different bundled pricing of insurance coverage and deductible coverage. A selection button 504 is provided corresponding to each pricing wherein the selection leads to a payment gateway for payment of the bundled pricing.

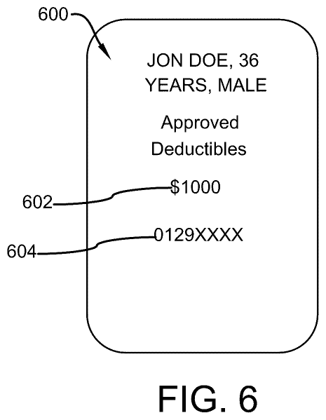

FIG. 6 illustrates a user interface shown to a user by the system for successful deductible coverage in accordance with one embodiment of the present invention. As illustrated, the user interface 600 displays a deductible coverage amount 602 approved by the insurance premium and deductible bundle system 100. The interface 600 also displays an account 604 in which the amount 602 is automatically transferred by the system 100. In case the deductible coverage is not approved, then, a message can be transmitted to the user indicating the reason for non-approval of the deductible coverage.

Certain terms are used throughout the following description and claims to refer to particular features or components. As one skilled in the art will appreciate, different persons may refer to the same feature or component by different names. This document does not intend to distinguish between components or features that differ in name but not structure or function. As used herein “automated insurance deductible coverage system”, “insurance deductible coverage system”, “insurance premium and deductible bundle system”, and “system” are interchangeable and refer to the automated insurance deductible coverage system 100 of the present invention.

Notwithstanding the forgoing, the automated insurance deductible coverage system 100 of the present invention can be of any suitable size and configuration as is known in the art without affecting the overall concept of the invention, provided that it accomplishes the above stated objectives. One of ordinary skill in the art will appreciate that the automated insurance deductible coverage system 100 as shown in the FIGS. are for illustrative purposes only, and that many other configurations of the automated insurance deductible coverage system 100 are well within the scope of the present disclosure.

Various modifications and additions can be made to the exemplary embodiments discussed without departing from the scope of the present invention. While the embodiments described above refer to particular features, the scope of this invention also includes embodiments having different combinations of features and embodiments that do not include all of the described features. Accordingly, the scope of the present invention is intended to embrace all such alternatives, modifications, and variations as fall within the scope of the claims, together with all equivalents thereof.

What has been described above includes examples of the claimed subject matter. It is, of course, not possible to describe every conceivable combination of components or methodologies for purposes of describing the claimed subject matter, but one of ordinary skill in the art may recognize that many further combinations and permutations of the claimed subject matter are possible. Accordingly, the claimed subject matter is intended to embrace all such alterations, modifications and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

What is claimed is:

1. An insurance deductible coverage system comprising:
a mobile application;
a website;
an electronic computing device;
a server;
a plurality of customers;
a customer database;
an insurance provider database;
a claims database; and
an application programming interface module;
wherein said plurality of customers use said mobile application to browse, select, and manage an insurance deductible rate;
wherein said plurality of customers use said mobile application to browse and select an insurance plan option;
wherein said electronic computing device is selected from the group consisting of a laptop, a smartphone, and a smartwatch;
wherein said server having said customer database including user information;
wherein said user information includes information selected from the group consisting of personal details, policy selections, deductible coverage details, and payment history;
wherein said insurance provider database is configured to maintain approved insurance providers;
wherein said insurance provider database having information selected from the group consisting of said insurance plan option, an insurance premium rate, said insurance deductible rate, and historical data on claims; and
further wherein said insurance provider database is updated in real-time to include and exclude said approved insurance providers.

2. The insurance deductible coverage system of claim 1, wherein said claims database having information selected from the group consisting of a deductible claim, a claim status, a claim date, a claim amount, and a claim verification detail to track a user claim history.

3. The insurance deductible coverage system of claim 2, wherein said application programming interface module interfaces with insurance providers for receiving real-time access to said premium rates, said insurance deductible rates, and said insurance plan options.

4. The insurance deductible coverage system of claim 3, wherein said application programming interface module compares said insurance deductible rate and said premium rate.

5. The insurance deductible coverage system of claim 4, wherein said application programming interface module including information selected from the group consisting of a subscription fee and a deductible reimbursement provided to said plurality of customers.

6. The insurance deductible coverage system of claim 5, wherein said server having a risk assessment and optimization module for analyzing a user data, a claim history, a likelihood of a user making a claim to deduce said insurance deductible rate, said premium rate, and said insurance plan option.

7. The insurance deductible coverage system of claim 6, wherein said risk assessment and optimization module suggests a cost-effective said insurance deductible rate and said insurance plan option based on said user claim history.

8. An insurance deductible coverage system comprising:
a mobile application;
a website;
an electronic computing device;
a server;
a plurality of customers;
a customer database;
an insurance provider database;
a claims database;
an application programming interface module;
a claim verification module; and
a communication network;
wherein said plurality of customers use said mobile application to browse, select, and manage an insurance deductible rate;
wherein said plurality of customers use said mobile application to browse and select an insurance plan option;
wherein said electronic computing device is selected from the group consisting of a laptop, a smartphone, and a smartwatch;
wherein said server having said customer database including user information;
wherein said user information includes information selected from the group consisting of personal details, policy selections, deductible coverage details, and payment history;
wherein said insurance provider database is configured to maintain approved insurance providers;
wherein said insurance provider database having information selected from the group consisting of said insurance plan option, an insurance premium rate, said insurance deductible rate, and historical data on claims;
wherein said insurance provider database is updated in real-time to include and exclude said approved insurance providers;
wherein said claim verification module validate claims with said approved insurance providers to ensure eligibility and accuracy of said claims before covering said insurance deductible rate; and
further wherein said mobile application and said website access said insurance deductible rate and said insurance premium rate through said communication network.

9. The insurance deductible coverage system of claim 8, wherein said claims database having information selected from the group consisting of a deductible claim, a claim status, a claim date, a claim amount, and a claim verification detail to track a user claim history.

10. The insurance deductible coverage system of claim 9, wherein said application programming interface module interfaces with insurance providers for receiving real-time access to said premium rates and said insurance deductible rates and said insurance plan options.

11. The insurance deductible coverage system of claim 10, wherein said application programming interface module compares said insurance deductible rate and said premium rate.

12. The insurance deductible coverage system of claim 11, wherein said application programming interface module including information selected from the group consisting of a subscription fee and a deductible reimbursement provided to said plurality of customers.

13. The insurance deductible coverage system of claim 12, wherein said server having a risk assessment and optimization module for analyzing a user data, a claim history, a likelihood of a user making a claim to deduce said insurance deductible rate, said premium rate, and said insurance plan option.

14. The insurance deductible coverage system of claim 13, wherein said risk assessment and optimization module suggests a cost-effective said insurance deductible rate and said insurance plan option based on said user claim history.

15. An insurance deductible coverage system comprising:
a mobile application;
a website;
an electronic computing device;
a server;
a plurality of customers;
a customer database;
an insurance provider database;
a claims database;
an application programming interface module; and
a communication network;
wherein said plurality of customers use said mobile application to browse, select, and manage an insurance deductible rate;
wherein said plurality of customers use said mobile application to browse and select an insurance plan option;
wherein said electronic computing device is selected from the group consisting of a laptop, a smartphone, and a smartwatch;
wherein said server having said customer database including user information;
wherein said user information includes information selected from the group consisting of personal details, policy selections, deductible coverage details, and payment history;
wherein said insurance provider database is configured to maintain approved insurance providers;
wherein said insurance provider database having information selected from the group consisting of said insurance plan option, an insurance premium rate, said insurance deductible rate, and historical data on claims;
wherein said insurance provider database is updated in real-time to include and exclude said approved insurance providers;
wherein said mobile application and said website access said insurance deductible rate and said insurance premium rate through said communication network;
wherein said application programming interface module compares said insurance deductible rate and said premium rate; and
further wherein said application programming interface module bundles said insurance deductible rate and said premium rate for selection of said insurance plan option.

16. The insurance deductible coverage system of claim 15, wherein said claims database having information selected from the group consisting of a deductible claim, a claim status, a claim date, a claim amount, and a claim verification detail to track a user claim history.

17. The insurance deductible coverage system of claim 16, wherein said application programming interface module interfaces with insurance providers for receiving real-time access to said premium rates and said insurance deductible rates and said insurance plan options.

18. The insurance deductible coverage system of claim 17, wherein said application programming interface module including information selected from the group consisting of a subscription fee and a deductible reimbursement provided to said plurality of customers.

19. The insurance deductible coverage system of claim 18, wherein said server having a risk assessment and optimization module for analyzing a user data, a claim history, a likelihood of a user making a claim to deduce said insurance deductible rate, said premium rate, and said insurance plan option.

20. The insurance deductible coverage system of claim 19, wherein said risk assessment and optimization module suggests a cost-effective said insurance deductible rate and said insurance plan option based on said user claim history.
